(19) United States
(12) Patent Application Publication
(10) Pub. No.: US 2011/0209607 A1
(43) Pub. Date: Sep. 1, 2011

(54) Apparatus and Method For Improved Weapon Configuration

(76) Inventor: Charles St. George, Murfreesboro, TN (US)

(21) Appl. No.: 13/019,539

(22) Filed: Feb. 2, 2011

Related U.S. Application Data
(60) Provisional application No. 61/337,358, filed on Feb. 2, 2010.

(51) Int. Cl. F41A 5/18; F41C 7/00; F41A 7/00; F41A 19/00; F41A 35/02; B23P 17/04

(52) U.S. Cl. 89/191.01; 29/428

(57) ABSTRACT

Disclosed herein is a rifle. The rifle includes a body receiver, a barrel, a bolt carrier system, a trigger assembly, and a gas system. The barrel extends from an end of the body receiver. The bolt carrier system is movably connected in the body receiver. The bolt carrier system includes a bolt and a bolt carrier. The trigger assembly is connected to the bolt carrier system. The trigger assembly includes a hammer and a sear. The trigger assembly is at a side portion of the bolt carrier. The gas system is connected between the bolt carrier system and the barrel.

### CROSS REFERENCE TO RELATED APPLICATION

This application claims priority under 35 U.S.C. §119(e) to U.S. provisional patent application No. 61/337,358 filed Feb. 2, 2010 which is hereby incorporated by reference in its entirety.

### BACKGROUND

1. Field of the Invention

The invention relates to a rifle and, more particularly, to self loading rifles which use the energy generated from the firing of the first cartridge to automatically extract and eject the spent case of the first round and load a fresh round into the chamber.

2. Brief Description of Prior Developments

Firearms, particularly those that are built to fire powerful cartridges such as the .50 BMG (.50 caliber Browning Machine Gun) round requires various devices to help reduce the recoil to an acceptable level while operating the weapon. Firearms that operate as above are known either as recoil or gas operated.

A recoil operated firearm generally allows the barrel (locked with the breech) to recoil rearwards within the receiver, and at a given point the barrel separates from the breech halting its rearward travel, whilst the breech mechanism continues rearwards extracting and ejecting the spent case. On its return stroke, the breech mechanism picks up a fresh round and loads it into the chamber.

To reduce the strong recoil, a muzzle brake may be attached to the front of the barrel. However, because this type of weapon relies on recoil to cycle the weapon, the muzzle brake's efficiency has to be limited, otherwise it will reduce the recoil necessary to operate the reloading cycle of the weapon. Further, because the barrel recoils inside the receiver, the receiver is heavy and complex in design, as it has to provide strong anchor points for the barrel recoiling system and the springs necessary for both the barrel and breech, that both operate separately during the cycle of operation.

Generally, in a gas operated weapon, a muzzle brake is still needed to reduce the recoil, which can be more efficient in its function, since the cycling of the weapon is not dependent on the recoil of the weapon. A gas operated weapon with a very efficient muzzle brake can be lighter in weight and shorter when having a “bullpup” configuration.

Additionally, gas operated and recoil operated firearms, in their current design and configuration, impede the design of shorter and more compact larger caliber firearms. Generally, the length of the breech system is determined by the length of the cartridge case and bullet and the firing system and positioned behind the magazine and able to reach the firing pin in the breech bolt. In addition, the receiver should be of sufficient length to allow full rearward travel of the breech to fully extract and eject the spent case and re-arming the hammer ignition system.

Furthermore, conventional rifles have their firing mechanisms positioned behind the magazine and ahead of the stock. A more recent configuration called a “bullpup” places the firing mechanism in front of the magazine eliminating the need for a separate stock and reduces the overall length of the firearm and its weight accordingly.

Firearms having bullpup configurations are known in the art. For example, one type of firearm having a bullpup configuration is the Steyr AUG. The Steyr AUG is a bullpup assault rifle used in several countries such as Austria and Australia. However, various other types of firearms having bullpup configurations are known in the art.

However, conventional bullpup rifles with a trigger positioned in front of the magazine are generally not practical for larger cartridges. The trigger may be inconveniently positioned too far forward causing excessive trigger pull or decreasing the precision of the firearm.

Therefore, there is a need for a self loading bullpup firearm with a compact breech and hammer mechanisms in smaller configurations which are not restricted by the overall length of the larger cartridge such as the .50 BMG and therefore reduces the overall length and weight of the firearm.

### SUMMARY

The foregoing and other problems are overcome, and other advantages are realized, by the use of the exemplary embodiments of this invention.

In accordance with one aspect of the invention, a bullpup self loading rifle is disclosed. The bullpup rifle is adapted for firing high powered cartridge cases such as the .50 BMG rounds, having a body receiver, which may include combination handguards, a gas cylinder and slide attached to the breech mechanism and slidable inside the body receiver, and a firing mechanism fixed inside the body receiver, allowing for a much shorter breech bolt assembly and a much shorter and lighter firearm having a single piece body receiver that supports the barrel and gas system assembly, bolt carrier group, the hammer ignition group and the hammer sear release mechanism for trigger actuation, a dust cover assembly and means to cock the breech bolt assembly manually to load the first round into the chamber and said cocking means not reciprocating during the said firing of the firearm.

In accordance with one aspect of the invention, a rifle is disclosed. The rifle includes a body receiver, a barrel, a bolt carrier system, a trigger assembly, and a gas system. The barrel extends from an end of the body receiver. The bolt carrier system is movably connected in the body receiver. The bolt carrier system includes a bolt and a bolt carrier. The trigger assembly is connected to the bolt carrier system. The trigger assembly includes a hammer and a sear. The trigger assembly is at a side portion of the bolt carrier. The gas system is connected between the bolt carrier system and the barrel.

In accordance with another aspect of the invention, a gas operated weapon is disclosed. The gas operated weapon includes a body receiver, a barrel, a bolt carrier system, a trigger assembly, and a dust cover. The body receiver has a first side, a second side, and an ejection port. The ejection port is at the first side. The barrel extends from an end of the body receiver. The bolt carrier system is movably connected in the body receiver. The bolt carrier system includes a bolt and a bolt carrier. The trigger assembly is connected to the bolt carrier system. The trigger assembly is proximate the second side of the body receiver. The dust cover is connected to the first side of the body receiver. At least a portion of the dust cover is over the ejection port. The dust cover is configured to open in response to a movement of the bolt carrier system in a first direction. The dust cover is configured to close in response to a movement of the bolt carrier system in a second different direction.

In accordance with another aspect of the invention, a method is disclosed. A body receiver is provided. A barrel is provided at the body receiver. The barrel extends from an end of the body receiver. A bolt carrier system is provided in the body receiver. The bolt carrier system includes a bolt and a bolt carrier. A trigger assembly is connected to the bolt carrier system. A gas system is connected between the bolt carrier system and the barrel. A dust cover is connected to the body receiver. The dust cover is proximate one side of the bolt carrier system. The trigger assembly is proximate another different side of the bolt carrier system.

### BRIEF DESCRIPTION OF THE DRAWINGS

The foregoing aspects and other features of the invention are explained in the following description, taken in connection with the accompanying drawings, wherein:

FIG. 1 is a side elevation view of the bullpup rifle in accordance with the description of the invention;

FIG. 2 is a perspective view of a bolt carrier system of the rifle shown in FIG. 1;

FIG. 2A illustrates front and section views of the bolt carrier system shown in FIG. 2;

FIG. 2B is a partial section view bolt carrier system and a barrel and barrel extension of the rifle shown in FIG. 1;

FIG. 3 is a perspective view of the rifle shown in FIG. 1 showing the bolt carrier system/group in relationship to the side mounted hammer ignition system, allowing for a short and compact bolt carrier group;

FIG. 4 is a view showing the forty-five degree locking rotation of the breech bolt inside the barrel extension of the rifle shown in FIG. 1;

FIG. 5 is a view showing the side mounted hammer ignition system held in place in the main body receiver of the rifle shown in FIG. 1, allowing for a short and compact bolt carrier group;

FIG. 6 shows partial section views of the hammer ignition system of the rifle shown in FIG. 1 in various stages of operations including the trigger bar release;

FIG. 6A is an exploded perspective view of the trigger assembly shown in FIG. 6;

FIG. 7 shows side views comparing a conventional full length bolt carrier group and the bolt carrier group of the rifle shown in FIG. 1 having a more compact and short configuration as described in this invention;

FIG. 8 shows a gas system assembly and expansion chamber (in its closed position) of the rifle shown in FIG. 1;

FIG. 9 shows the gas system assembly and expansion chamber shown in FIG. 8 during firing and said movement rearwards of the gas cylinder and slide attached to the bolt carrier group;

FIG. 9A is a section view of an alternate example of a gas system of the rifle shown in FIG. 1;

FIG. 9B is a perspective view showing a regulator valve and short stroke piston of the gas system shown in FIG. 9A;

FIG. 10 is a section view of the gas expansion chamber and gas port holes of the gas system that allows a rearward thrust function being imparted to the gas cylinder;

FIG. 11 is a side view of a dust cover of the rifle shown in FIG. 1 and the bolt carrier in a first position and a second position;

FIG. 12 shows a section view and perspective views of the dust cover;

FIG. 13 is an enlarged partial view of the dust cover;

FIG. 14 is a perspective view of a tool tray of the rifle shown in FIG. 1; and

FIG. 15 is a partial section view of the tool tray shown in FIG. 14 disposed in the body receiver of the rifle shown in FIG. 1.

### DETAILED DESCRIPTION

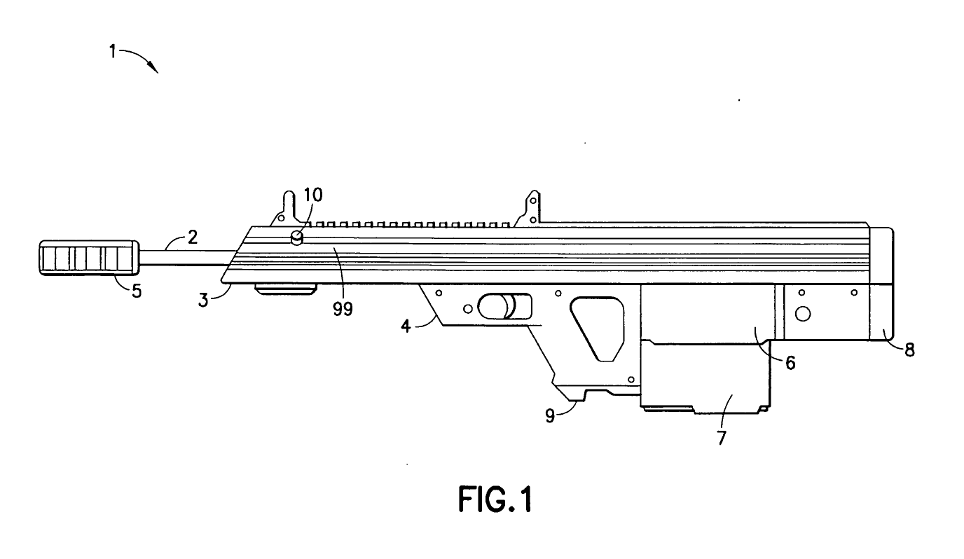

Referring to FIG. 1, there is shown a side elevation view of a bullpup rifle 1 incorporating features of the invention. Although the invention will be described with reference to the exemplary embodiments shown in the drawings, it should be understood that the invention can be embodied in many alternate forms of embodiments. In addition, any suitable size, shape or type of elements or materials could be used.

As required, detailed embodiments of the present invention are disclosed herein; however, it is to be understood that the disclosed embodiments are merely exemplary of the invention, which may be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure.

In general, the present invention relates to a self loading, gas operated rifle of a bullpup configuration referred to herein by referencing FIG. 1. The bullpup rifle 1 comprises a body receiver 3. The body receiver 3 serves as the super structure spine of the weapon. The body receiver also supports the entire operating mechanism that loads, locks the breech bolt to the barrel extension, fires the round, unlocks the breech bolt, extracts the fired round, continues rearwards and ejects said fired round's spent case and re-arms the hammer, and then returns forward and loads and chambers a fresh round ready to fire. The body receiver 3 also serves as an anchor for a trigger assembly, a pistol grip housing 4, a magazine well 6, and a round box magazine 7. However, it should be noted that any suitable type of magazine may be provided. The receiver 3 may be constructed of a durable material that is lightweight, rigid and may be constructed from an aluminum extrusion, plastic or carbon fiber. However, it should be noted that the body receiver 3 may comprise any suitable configuration and/or material.

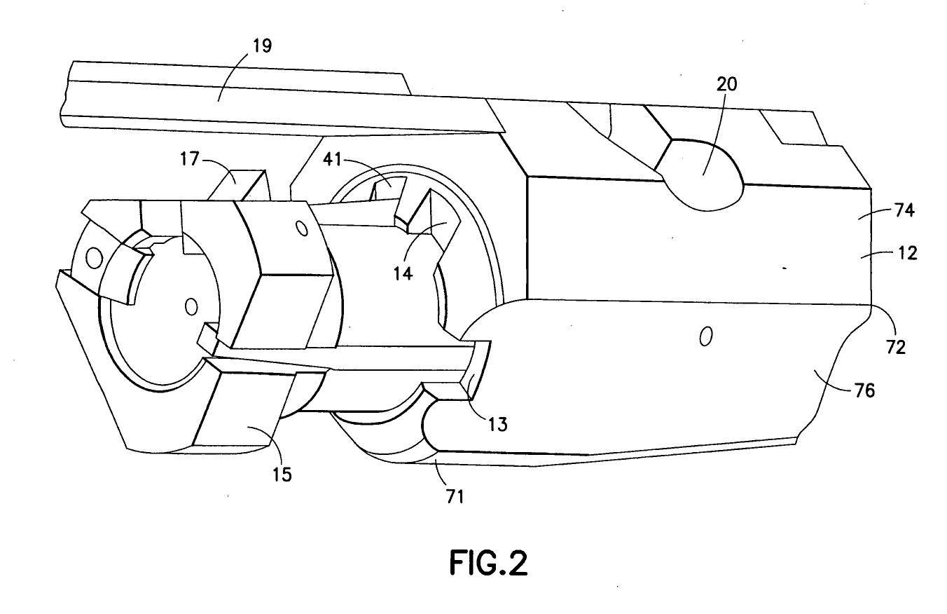

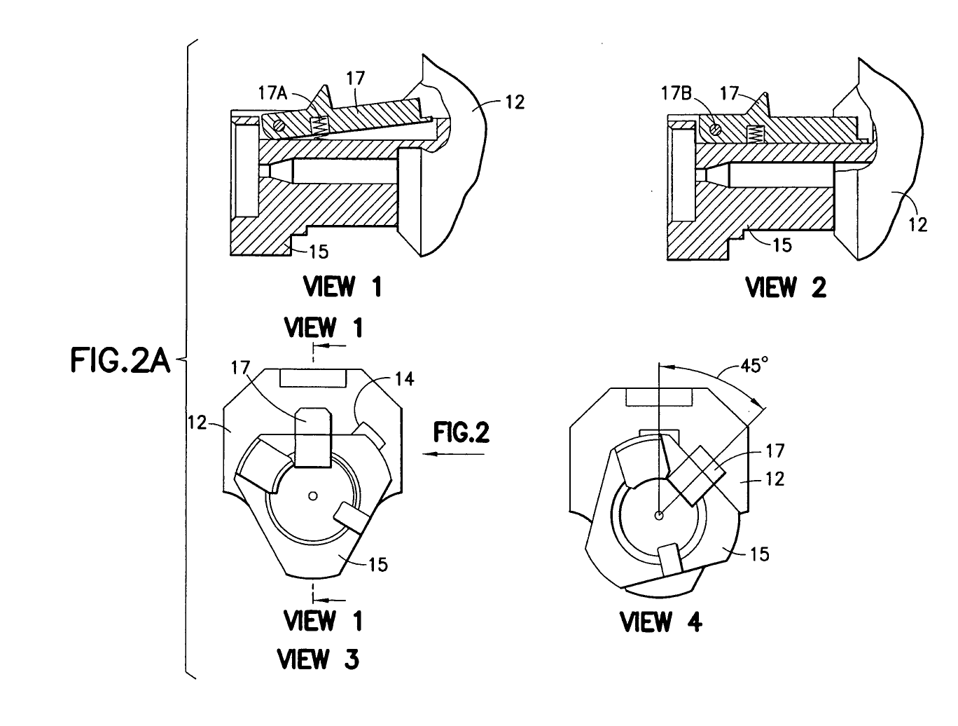

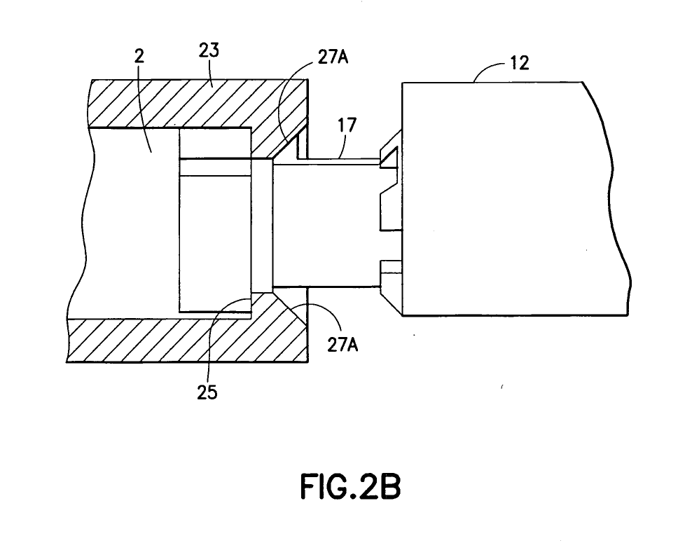

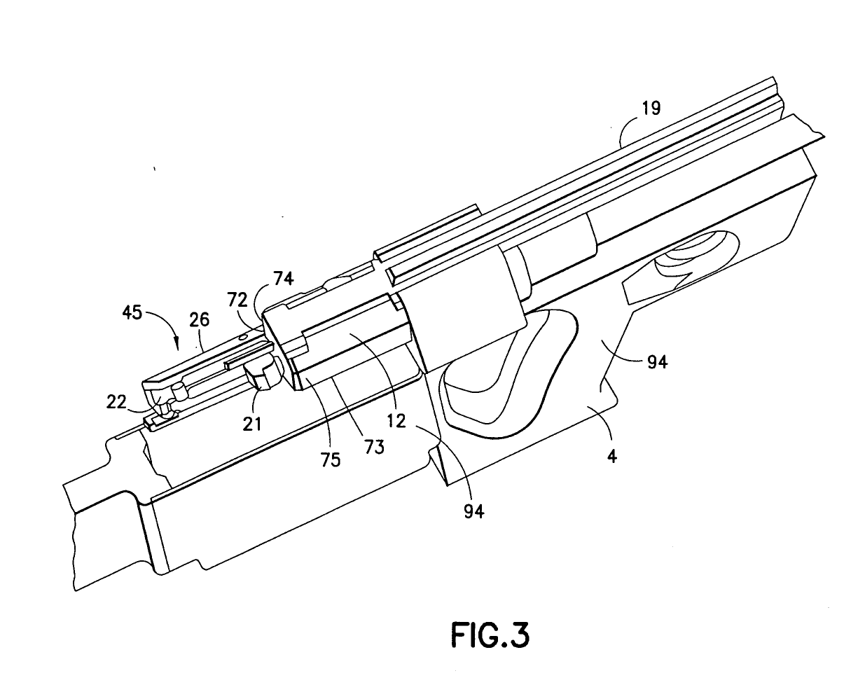

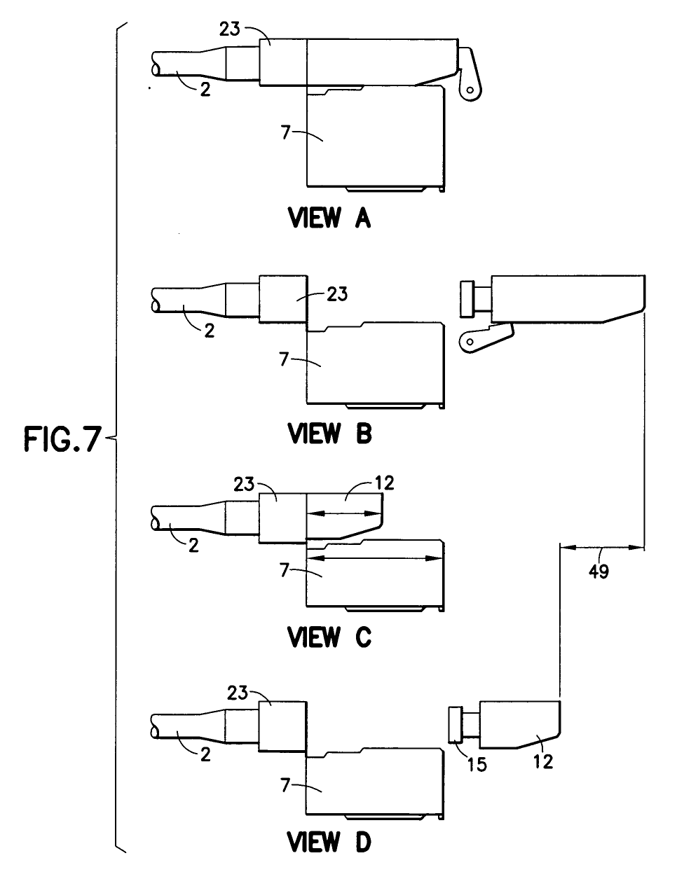

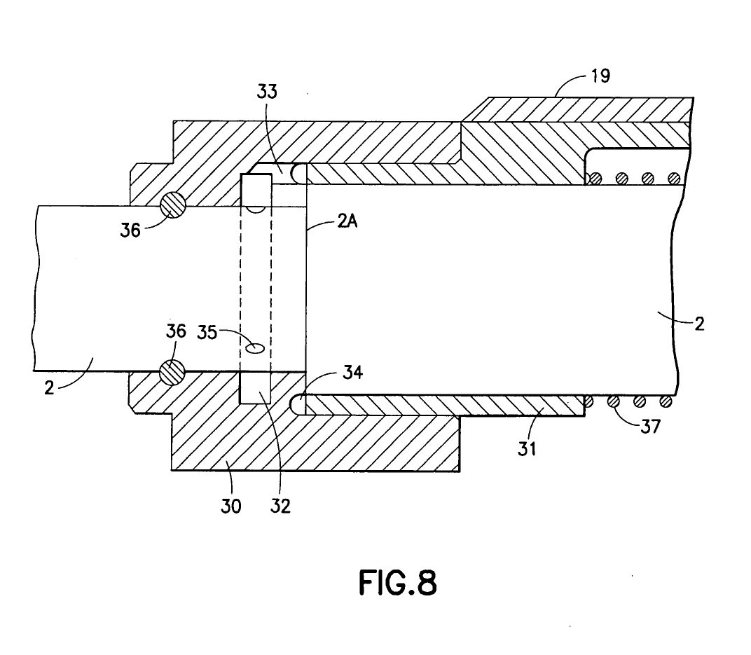

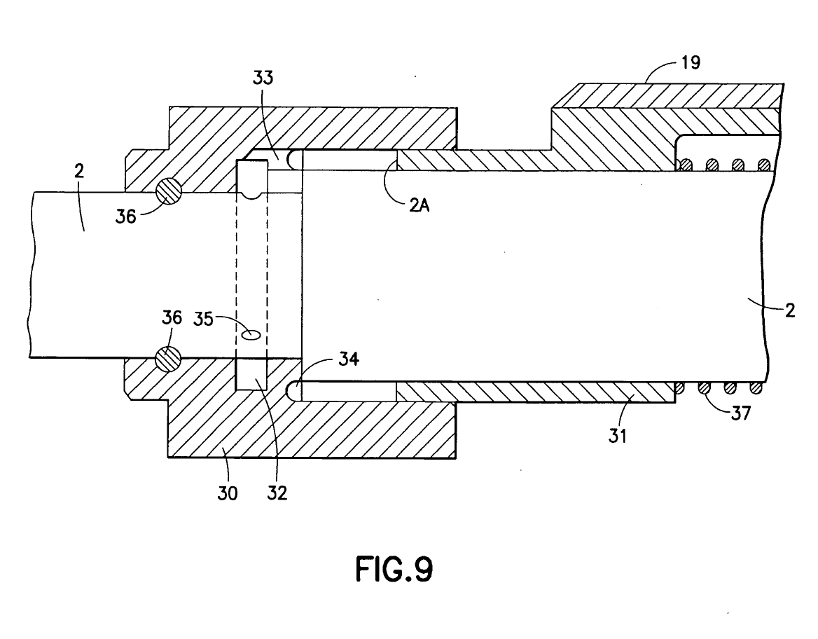

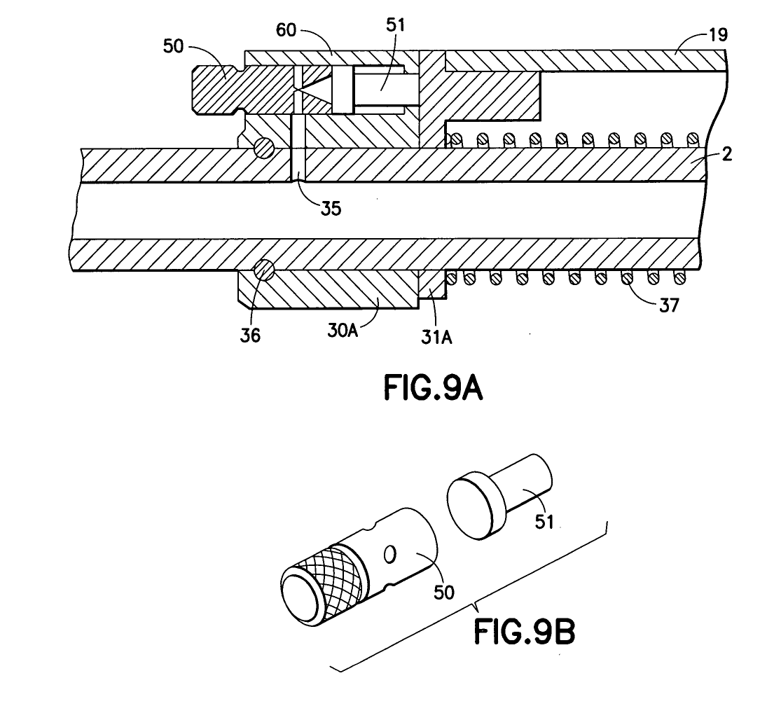

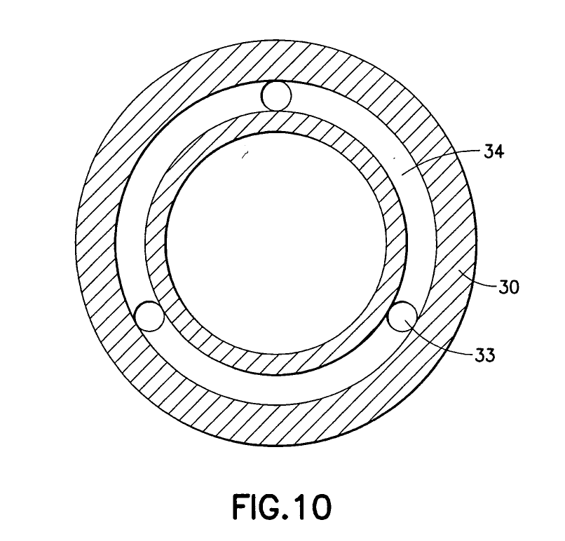

The body receiver body 3 further supports a barrel 2 and a muzzle brake 5. The muzzle brake 5 diverts the exiting expanded gasses to the side and rearwards of the weapon to reduce the recoil. Various types of conventional muzzle brakes are known in the art. However, the disclosed muzzle brake configuration, according to one or more exemplary embodiments of the invention, provides for improved efficiency since the muzzle brake uses expanding gasses as shown in FIG. 9. FIG. 8 illustrates the gas system in a closed position, wherein the barrel 2 is attached to the gas housing 30 by pins 36. FIG. 9 depicts a gas cylinder 31 (of the gas system), being sent rearwards as a result of the expanding gasses being allowed to exit barrel bleed holes 35. According to one example of the invention, three barrel bleed holes 35 equally spaced around the barrel may be provided. However, it should be noted that in alternate embodiments, any suitable number or spacing of the barrel bleed holes 35 may be provided. The escaping expanding gas enters the chamber 32 which allows for entering gas ports 33, which lead to expansion chamber 34. At this point, the expanding gasses act against a gas cylinder face 2A, sending the gas cylinder 31 and slide 19 together with the bolt carrier group 40 (see also FIGS. 2, 3). This commences the unlocking and unloading cycle whilst compressing the action spring 37 which, once the operating cycle is complete, will return the bolt carrier 12 towards the chamber and load another round into the chamber.

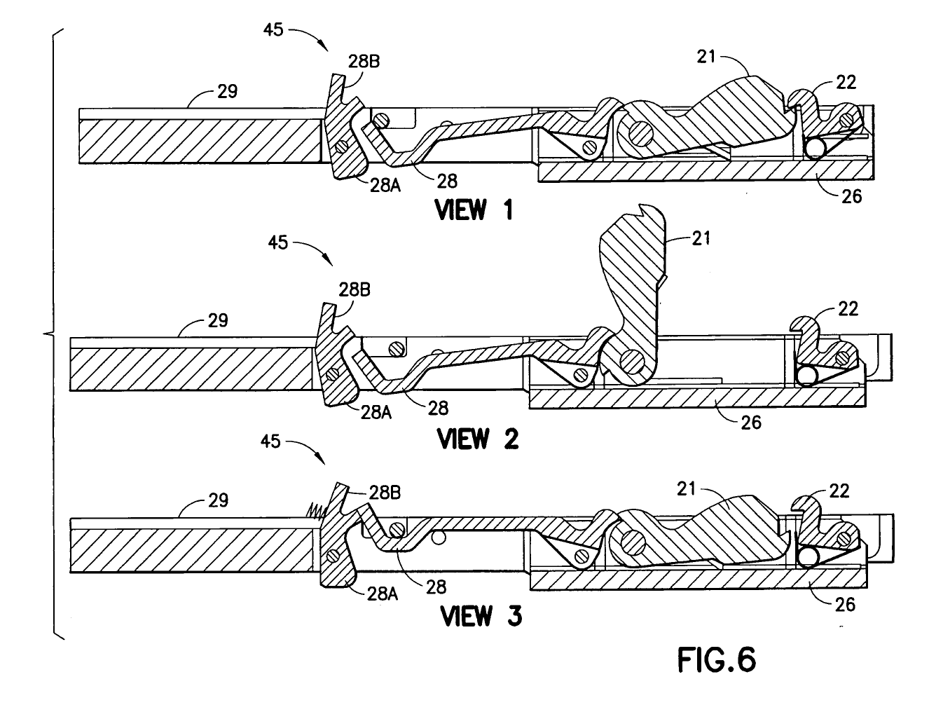

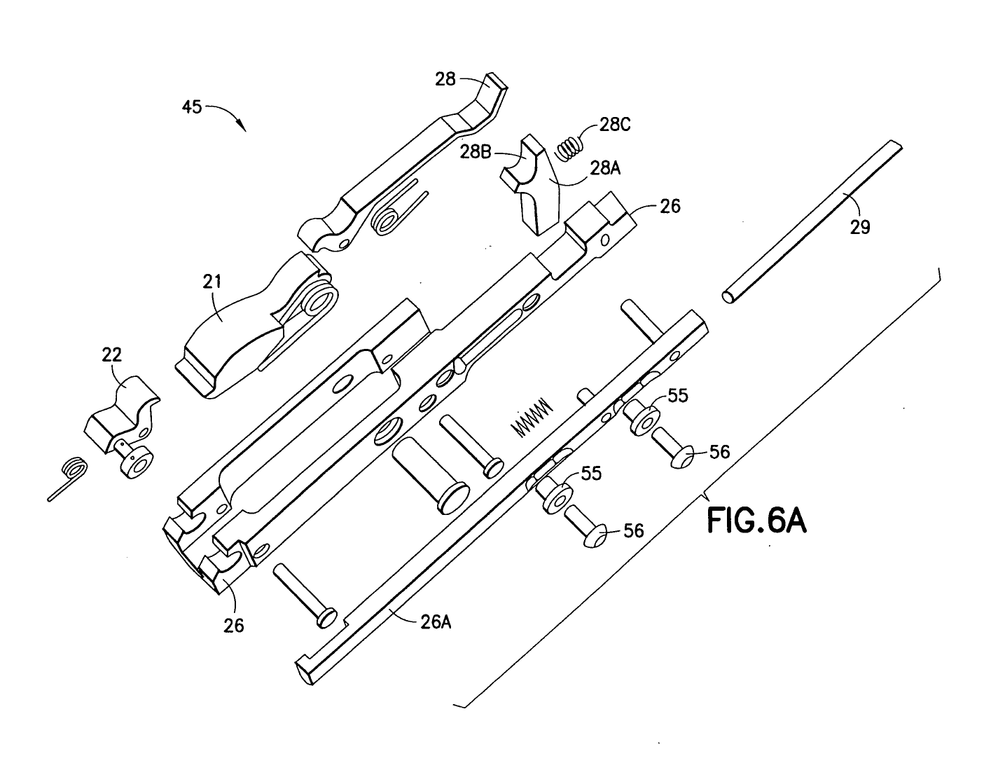

Firing a rifle using heavy caliber bullets such as the .50 BMG imparts to the related mechanical parts tremendous recoil and jarring. As a consequence, certain components such as the trigger mechanism, may benefit from the incorporation of devices to ensure safe and continuous cycling. FIG. 6 shows the trigger mechanism (or trigger assembly) 45, which works as follows. The bolt carrier 12 (see also FIG. 2) moves rearwards during the firing cycle and rotates the hammer 21 downwards, and it engages with sear 28 (see view 3 of FIG. 6) and in so doing, sear lock 28A moves to engage and prevents the sear 28 from releasing the hammer 21. The sear 22 is held rearwards by the trigger pushing the trigger bar 29 (see FIG. 6A). When the bolt carrier 12 returns forward, bolt carrier notch 13 (see also FIG. 2) moves to release sear lock 28A by engaging sear lock face 28B. The release bar 26A (see FIG. 6A) is still held backwards and when released by the operator (releasing the trigger), which in turn releases the trigger bar from engaging the release bar 26A, which allows the sear 28 to release the hammer 21, and the hammer 21 is then engaged by the sear 22 which has moved forward to engage the hammer 21 and be in a position to fire again (see view 1 of FIG. 6).

View 2 of FIG. 6 shows the hammer released and in a fired position. FIG. 6A also shows related parts. The release bar 26A is held to the assembly housing 26 with bushings 55, secured by screws 56. The entire assembly housing 26 may be removed from the upper receiver.

The trigger housing assembly 26 may be held in place by a buffer assembly that also houses a tool tray. This is held in position by a butt plate 8 (see FIG. 1).

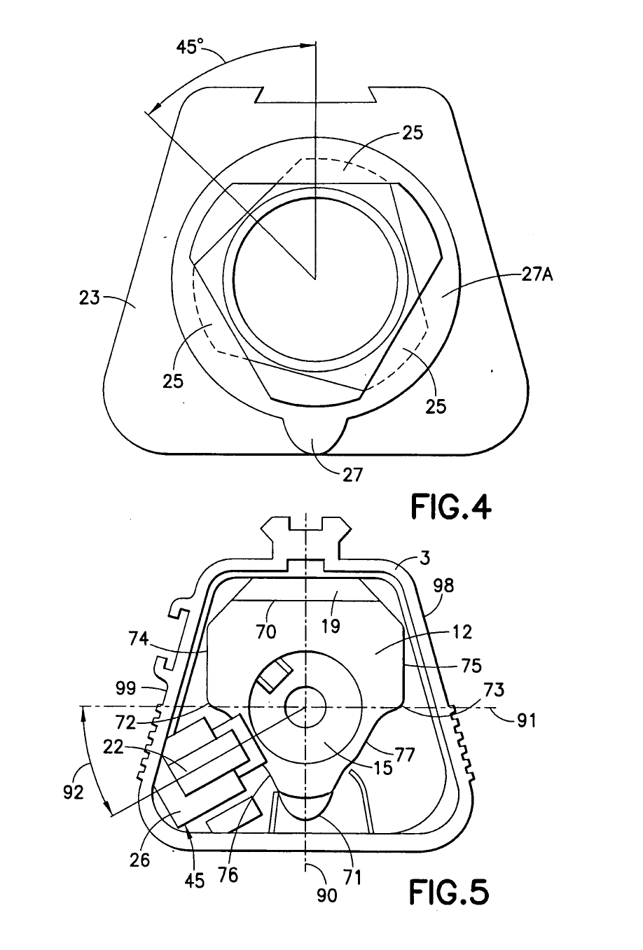

Referring now also to FIG. 2, bolt latch 17 allows the bolt 15 (of the bolt carrier system 40) to remain in a position that allows it to enter the barrel extension 23 (see FIG. 2B) without the bolt rotating through its cam track 20. The bolt latch 17 encounters an angled face 27A on the barrel extension 23 and further movement depresses the bolt latch 17, releasing its rear portion from bolt carrier notch 41, and allows the bolt to rotate and lock behind corresponding lock faces 25 (see FIG. 4). A rotation of about forty-five (45) degrees, for example, provides substantially more lock up area than other weapons using similar three lobed bolts. When the bolt carrier completes its locking rotation, the bolt latch 17 moves into a bolt carrier cutout 14.

FIG. 2A illustrates various views, and in particular view 1 of FIG. 2 shows the bolt latch locked to bolt carrier 12, and view 2 of FIG. 2A shows the bolt latch 17 depressed from the bolt carrier 12, allowing it to rotate as shown in view 4 of FIG. 2A.

Referring now also to FIG. 7, the two top views A, B of a bolt carrier group are shown. The top views A, B of FIG. 7 use conventionally placed hammers wherein the length of the rearward travel generally tends to extend the length of the weapon.

The lower 2 views (views C, D of FIG. 7) depict one exemplary embodiment of the current invention, having the trigger mechanism 45 mounted on the side at about thirty (30) degrees in the upper receiver and as shown in FIG. 3 and FIG. 5. This allows for a bolt carrier 12 having a reduced length (in a direction along a central axis of the rifle 1 [or central axis of the barrel 2]) when compared to conventional configurations (for example, see length reduction distance 49). According to some embodiments of the invention, bolt carrier may comprise a length that is less than a length dimension of the magazine 7 (and the cartridge) as shown in view C of FIG. 7. However, in alternate embodiments, any suitable bolt carrier length (or other bolt carrier dimensions) may be provided. With further reference to FIGS. 2, 3, 5, the bolt carrier 12 comprises a top portion 70, a bottom portion 71, and side portions 72, 73 (or lateral side portions) between the top portion 70 and the bottom portion 71. The side portions 72, 73 further comprise straight side portions 74, 75 and angled side portions 76, 77. The straight side portions 72, 73 are substantially parallel to a vertical plane 90 of the rifle 1 (and substantially perpendicular to a horizontal plane 91 of the rifle 1). The angled side portions are angled relative to the planes 90, 91. The angled side portion 76 provides a side mounted ramp for the trigger assembly 45 such that the trigger assembly 45 can be mounted on the side of the bolt carrier at an angle 92 of about thirty (30) degrees from the horizontal plane 91. It can further be noted that this configuration provides for the trigger assembly 45 to be at an angle with respect to lateral side portions 93, 94 of the rifle 1 (wherein the lateral side portions are substantially parallel to the vertical plane 90).

Referring now also to FIGS. 9A and 9B, there is shown an alternative example of a gas system, which uses a short stroke piston 51 and a regulator valve 50. The regulator valve 50 has four (4) gas entry holes which are in position so only one hole at a time can be positioned in line with the barrel gas port hole 35. However, it should be noted that in alternate embodiments any suitable position of the gas entry holes may be provided. The gas regulator valve allows a decrease or an increase of the amount of gas that enters into the expansion chamber 60. As the hot gas expands, it moves the head of the piston rearwards and moves slide 19, attached to the carrier 12 which moves rearwards and unlocks the breech bolt, and extracts and ejects the case from the weapon.

As shown in FIG. 1, the rifle further comprises a cocking/charging handle 10 disposed proximate a left side 99 of the receiver 3. The cocking/charging handle 10 is situated in the receiver extruded portion 3 allowing direct operation and a non reciprocating feature during firing of the weapon.

Referring now also to FIGS. 11-13, another exemplary embodiment of the invention is shown. This embodiment relates, for example, to semi-automatic rifles that use the ejection port provided to eject from the weapon, the fired case. Naturally, the larger the cartridge case, the larger ejection port needs to be, in order to allow the ejection of the much larger case. Some weapons of smaller caliber for example, provide a dust cover, which when in the closed position, is held by a spring loaded detent, and which is opened by the rearward travel of the bolt carrier. The dust cover is snapped open and remains open, until the operator manually closes the dust cover. In small weapons, and weapons that have bolt carriers that are much longer than the ejection port, this tends to limit the amount of dust and foreign matter that can enter the weapon.

According to various exemplary embodiments of the invention, the bolt carrier is much shorter than the ejection port, exposing the internal parts to dust for example, to a greater degree. Further, having a much larger cartridge case, means the ejection port opening is also very large. An object of this invention is to provide a dust cover that fully closes the ejection port and of most significance, is that the dust cover is always in the closed position, except when the weapon is fired. The bolt carrier rearward travel opens the dust cover and ejects the fired case. Upon the forward travel of the bolt carrier, the dust cover closes automatically. This permits the ejection port to be in the open position for a very short period of time. This reduces the time allowed for any dust or other foreign matter to enter the weapon, ensuring that the weapon remains cleaner for longer periods of operating requirements at or in situations, such as a firefight, when the weapon's performance and continued operation are needed the most.

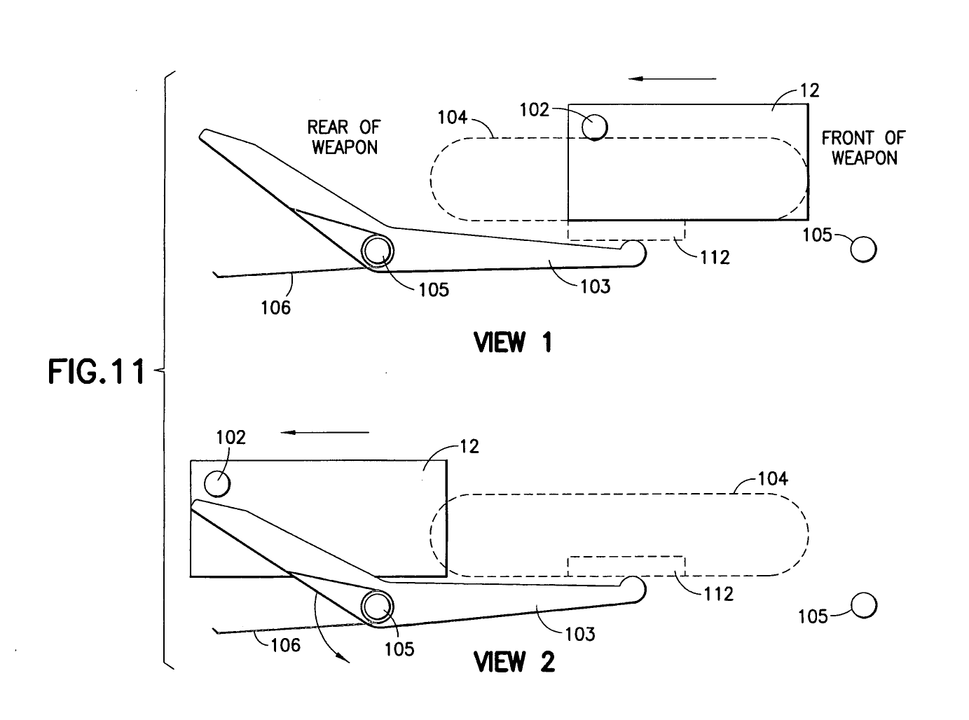

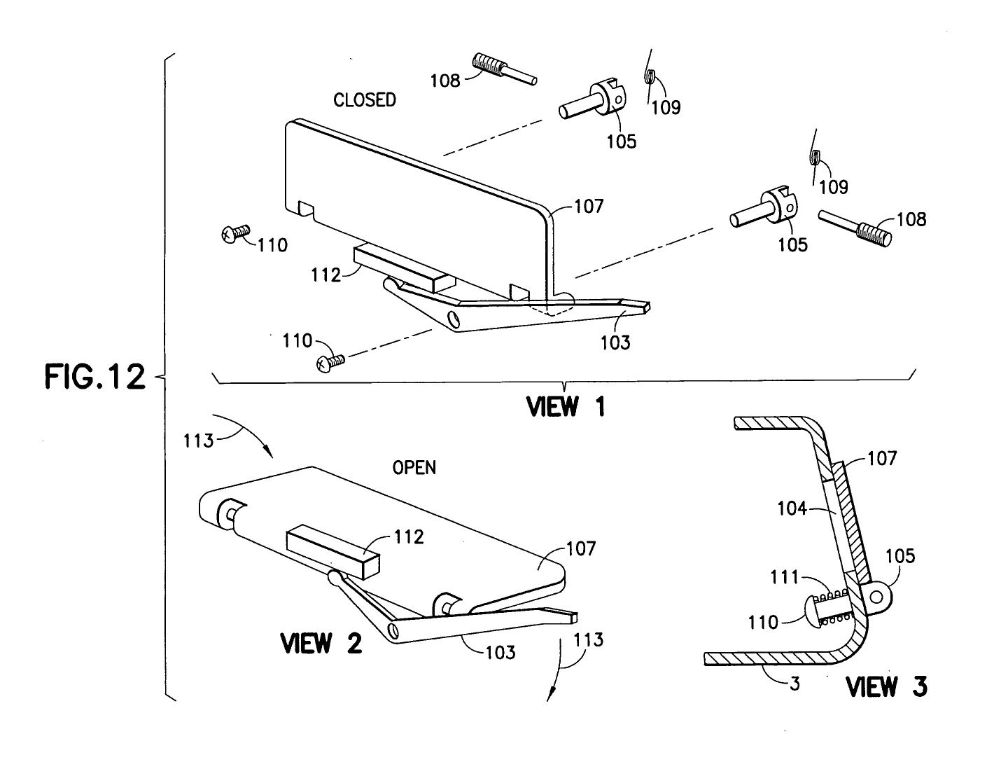

FIG. 11 illustrates two views of a dust cover assembly disposed proximate the ejection port 104 and the bolt carrier 12. View 1 of FIG. 11 shows the bolt carrier 12 in a forward closed position. An actuator cam 103 is in an upper most position held by a spring 106. In view 2 of FIG. 11 the bolt carrier 12 has moved rearwards (after having fired a round) and a stud 102 connects with the actuator cam 103 and rotates said actuator about its pivot point (pivot pin 105) and said forward portion of the actuator 103 connects with a cam face 112 of the dust cover 107 and causes the dust cover 107 to rotate in direction of arrows 113 (shown in FIG. 12). The dust cover 107 is able to pivot by the support pivot pins 105 wherein one of which also provides the pivot means for the actuator arm. As the bolt carrier moves forward, the bolt carrier stud 102 moves away from the actuator which under its own spring tension (from the spring 106), returns to its former position allowing the dust cover 107 to rotate via the pivot pins 105 and under a spring pressure of springs 109, to the closed position, thereby sealing the ejection port completely.

The pivot pins 105 are secured with springs 111 at two points and fastened with two screws 110. The extrusion body (or body receiver) 3 provides the two holes necessary to secure the dust cover assembly, as shown in view 3 of FIG. 12 (wherein view 3 of FIG. 12 illustrates a partial section view). As shown in view 3 of FIG. 12, the dust cover is mounted on a right side 98 of the receiver 3, and is spring biased in the closed position to cover the ejection port 104.

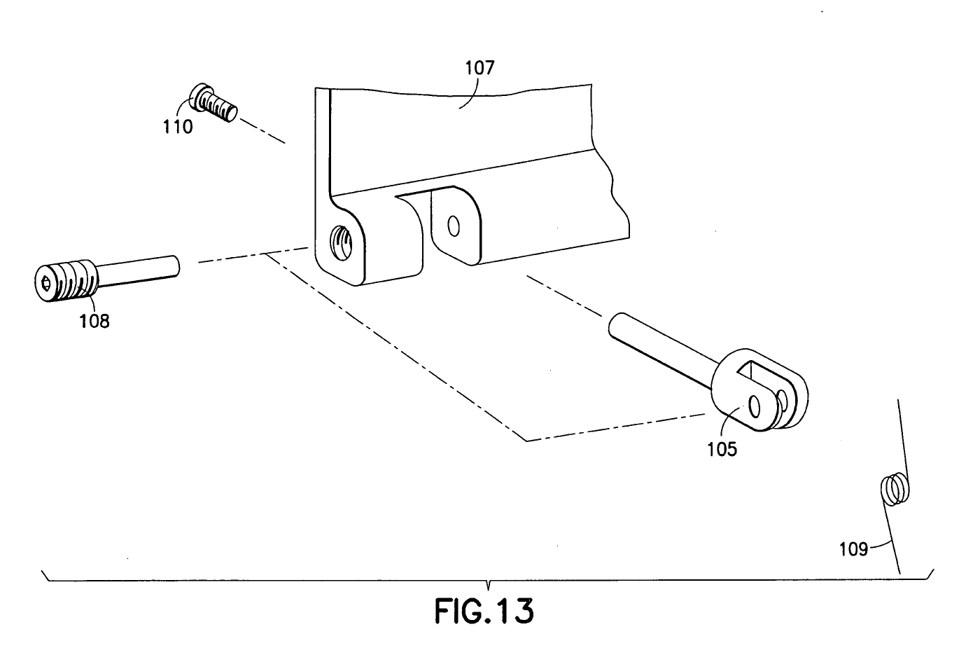

FIG. 13 shows the relationship of the pivots 105 and how they are secured to the dust cover via a lock stud 108, which also secures the springs 109 and prevents the pivot pins 105 from rotating about their axis, and provides the means for the dust cover 107 to open and close and provide secure means for said springs 109 to keep the dust cover closed, unless it is opened by the actuator cam 103 under operation from the firing of the weapon.

Various exemplary embodiments of the invention provide a sealed action to the weapon through the otherwise normally opened ejection port. It should be noted that, as described above, according to various exemplary embodiments the dust cover is opened during the firing cycle, that is, as the bolt carrier moves rearwards it actuates the cam which in turn opens the dust cover. However, the location of the cam as illustrated in FIGS. 11, 12 is provided as a non-limiting example. In alternate embodiments, any other suitable location (or configuration) for the cam, wherein the cam is actuated by the rearward movement of the bolt carrier and closes as the bolt carrier returns to its closed position, may be provided.

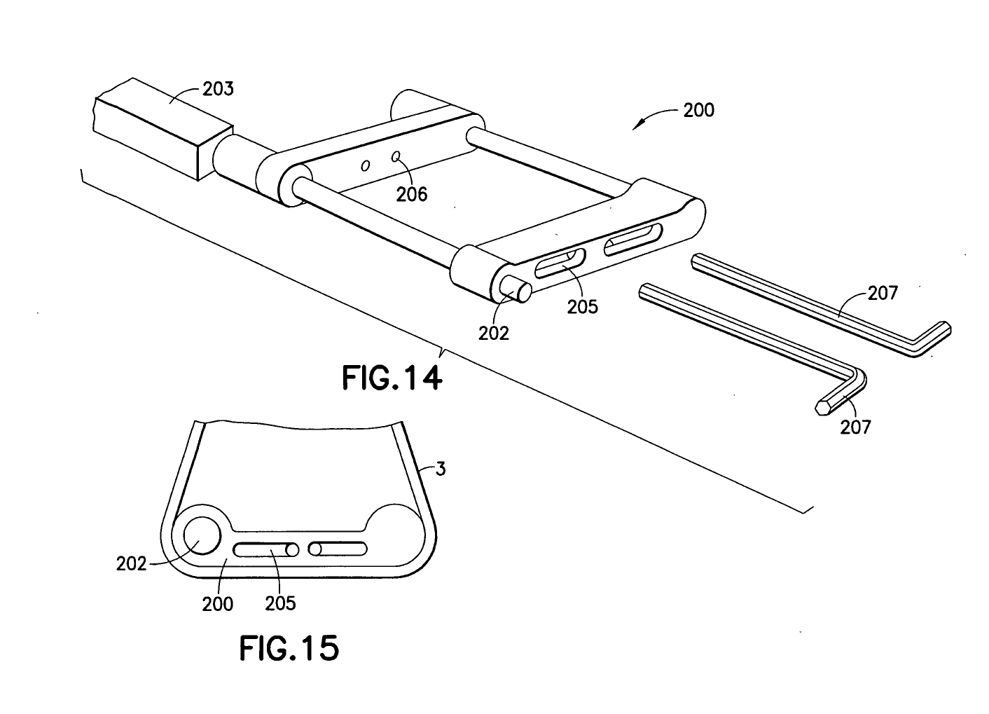

Referring now also to FIGS. 14, 15, another exemplary embodiment of the invention is shown. This embodiment relates, for example, to weapons having a storage space within the weapon. The storage space is able to contain a tool tray 200 which forms part of the Weapon's trigger retaining assembly system and its recoil buffer means. The tool tray 200 is held in the forward position by a trigger housing 203 and its rear position by the butt plate, not shown, but it keeps the tool tray positioned at the end of the extrusion compressing the buffer 202. The angled sides of the extrusion prevents the tray from moving up into the action space of the recoiling bolt carrier mechanism. There is provided recesses 205 to allow, for example, allen wrenches 207 to fit flush with the rear of the extrusion, and recesses 206 to secure the longer portion of the alien wrenches. It should be noted that although the tool tray has been described with reference to allen wrenches, any other suitable tools may be accommodated within the tool tray. For example, other tools with other configurations can be provided to secure parts or tools necessary for weapon's maintenance. The tray can be removed from the weapon without any tools.

Below are provided further descriptions of various non-limiting, exemplary embodiments. The below-described exemplary embodiments are separately numbered for clarity and identification. This numbering should not be construed as wholly separating the below descriptions since various aspects of one or more exemplary embodiments may be practiced in conjunction with one or more other aspects or exemplary embodiments. That is, the exemplary embodiments of the invention, such as those described immediately below, may be implemented, practiced or utilized in any combination (e.g., any combination that is suitable, practicable and/or feasible) and are not limited only to those combinations described herein and/or included in the appended claims.

In one exemplary embodiment, an apparatus comprising a receiver, extruded which houses the barrel assembly, removable trigger assembly, gas system and breech bolt assembly, tool kit combo with recoil buffer system and means to charge the weapon.

In another exemplary embodiment, an apparatus comprising a bolt carrier system (or bolt carrier assembly) with extended locking rotation and side mounted ramp to allow side hammer cocking and firing, thereby reducing overall length of weapon.

The above, for example, allows a much shorter bolt carrier assembly thereby providing a much shorter weapon, therefore less materials translate into a much lighter weapon.

In another exemplary embodiment, an apparatus comprising a removable trigger assembly buffer system with adjustable recoil absorption option and combination tool tray.

In another exemplary embodiment, an apparatus comprising a gas system using a short stroke piston and control valve, thereby ensuring a clean operated gas system without imparting any gas residue into the working parts of the weapon.

In another exemplary embodiment, an apparatus comprising a dust cover that remains closed save during the operation of the weapon to release fired and or un-fired cartridge cases. This ensures that the ejection opening is held to a minimum and reduces the time the ejection port is open to the elements.

In another exemplary embodiment, an apparatus comprising a cocking/charging handle situated in the receiver extruded portion allowing direct operation and a non reciprocating feature during firing of the weapon.

In another exemplary embodiment, an apparatus comprising a gas system using a short stroke piston and gas valve regulator with a number of varying settings as to vary the volume of gas necessary to operate the weapon. Further, a detent feature that securely locks the desired gas flow selection in place.

In another exemplary embodiment, an apparatus comprising a two piece trigger and trigger rod firing system that allows easy stripping of the lower receiver from the upper receiver with the trigger rod remaining in the upper receiver.

In another exemplary embodiment, an apparatus comprising a pistol grip assembly 4 with a cavity provided for stowage of tools and spare parts. The cavity may be accessible that a removable cover 9 (see FIG. 1).

In another exemplary embodiment, an apparatus comprising a muzzle brake design that allows the use of aluminum and steel in such a way as to provide baffles capable of operating at high temperature and still exhibiting a lightweight muzzle brake.

In another exemplary embodiment, an apparatus comprising a recoil spring design that allows for varying the spring wire diameter able to alter the cycle rate of the weapon.

In another exemplary embodiment, an apparatus comprising a simple means to dislodge the bolt carrier assembly and slide from the gas system, allowing the removable of the bolt carrier assembly from the weapon without the need to separate the upper receiver from the lower receiver.

In another exemplary embodiment, a rifle comprising a body receiver, a barrel, a bolt carrier system/group, a trigger assembly, and a gas system. The barrel extends from an end of the body receiver. The bolt carrier system is movably connected in the body receiver, wherein the bolt carrier system comprises a bolt and a bolt carrier. The trigger assembly is connected to the bolt carrier system, wherein the trigger assembly comprises a hammer and a sear, and wherein the trigger assembly is at a side portion of the bolt carrier. The gas system is connected between the bolt carrier system and the barrel.

A rifle as above wherein the trigger assembly is mounted at an angled side portion of the bolt carrier, and wherein the trigger assembly is at an angle with respect to lateral side portions of the rifle.

A rifle as above further comprising a slide between the gas system and the bolt carrier system, wherein the body receiver comprises a one piece member, and wherein the body receiver houses the bolt carrier system, the trigger assembly, the gas system, the slide, and at least a portion of the barrel.

A rifle as above further comprising a cocking/charging handle at the body receiver, wherein the cocking/charging handle is configured to allow for direct operation and non-reciprocation during firing of the weapon.

A rifle as above wherein the rifle comprises a bullpup self loading rifle adapted to fire .50 BMG rounds.

A rifle as above further comprising a dust cover connected to the body receiver, wherein the dust cover is configured to be actuated by a movement of the bolt carrier.

A rifle as above wherein the bolt of the bolt carrier system is adapted for an extended locking rotation, wherein the locking rotation is about forty five degrees.

A rifle as above wherein the bolt carrier system and the trigger assembly are configured to allow for side hammer cocking and firing.

A rifle as above wherein the trigger assembly comprises a removable trigger assembly, and wherein the rifle further comprises a combination tool tray, and wherein the rifle includes an adjustable recoil absorption option.

A rifle as above wherein the gas system comprises regulator valve and a short stroke piston, wherein the gas system is configured to operate without imparting gas residue on the bolt carrier system and the trigger assembly.

In another exemplary embodiment, a gas operated weapon comprising a body receiver, a barrel, a bolt carrier system, a trigger assembly, and a dust cover. The body receiver has a first side, a second side, and an ejection port, wherein the ejection port is at the first side. The barrel extends from an end of the body receiver. The bolt carrier system is movably connected in the body receiver, wherein the bolt carrier system comprises a bolt and a bolt carrier. The trigger assembly is connected to the bolt carrier system, wherein the trigger assembly is proximate the second side of the body receiver. The dust cover is connected to the first side of the body receiver, wherein at least a portion of the dust cover is over the ejection port, wherein the dust cover is configured to open in response to a movement of the bolt carrier system in a first direction, and wherein the dust cover is configured to close in response to a movement of the bolt carrier system in a second different direction.

A gas operated weapon as above wherein the first direction comprises a direction towards a front end of the gas operated weapon, and wherein the second different direction comprises a direction towards a rear end of the gas operated weapon.

A gas operated weapon as above wherein the trigger assembly is mounted at a side ramp of the bolt carrier, wherein the trigger assembly is at an angle relative to a horizontal plane of the weapon, and wherein the angle is about thirty degrees.

A gas operated weapon as above wherein the dust cover is configured to be biased in a closed position, and wherein the dust cover is configured to only open during operation of the weapon to release fired and/or un-fired cartridge cases.

A gas operated weapon as above wherein the trigger assembly comprises a two piece trigger and trigger rod firing system configured for allowing stripping of a lower receiver from an upper receiver with the trigger rod remaining in the upper receiver.

A gas operated weapon as above further comprising a muzzle brake comprising a baffles portion.

A gas operated weapon as above further comprising a recoil spring configured to allow for varying the spring wire diameter for altering the cycle rate of the weapon.

A gas operated weapon as above further comprising a slide between the bolt carrier system and the body receiver, wherein the bolt carrier system and the slide are configured to be removable from the gas system, and wherein the bolt carrier system is configured to be removable from the weapon without separating an upper receiver of the weapon from a lower receiver of the weapon.

According to another example of the invention, a method is disclosed. The method includes the following steps. Providing a body receiver. Providing a barrel at the body receiver, wherein the barrel extends from an end of the body receiver. Providing a bolt carrier system in the body receiver, wherein the bolt carrier system comprises a bolt and a bolt carrier. Connecting a trigger assembly to the bolt carrier system. Connecting a gas system between the bolt carrier system and the barrel. Connecting a dust cover to the body receiver, wherein the dust cover is proximate one side of the bolt carrier system, and wherein the trigger assembly is proximate another different side of the bolt carrier system. It should be noted that the order of the steps does not necessarily imply that there is a required or preferred order for the steps and the order and arrangement of the steps may be varied. Any of the above steps may be performed alone or in combination with one or more of the steps. Furthermore it may be possible for some steps to be omitted.

A method as above further comprising providing a tool tray proximate an opposite end of the body receiver.

It should be understood that components of the invention can be operationally coupled or connected and that any number or combination of intervening elements can exist (including no intervening elements). The connections can be direct or indirect and additionally there can merely be a functional relationship between components.

It should be understood that the foregoing description is only illustrative of the invention. Various alternatives and modifications can be devised by those skilled in the art without departing from the invention. Accordingly, the invention is intended to embrace all such alternatives, modifications and variances which fall within the scope of the appended claims.

What is claimed is:

1. A rifle comprising:
a body receiver;
a barrel extending from an end of the body receiver;
a bolt carrier system movably connected in the body receiver, wherein the bolt carrier system comprises a bolt and a bolt carrier;
a trigger assembly connected to the bolt carrier system, wherein the trigger assembly comprises a hammer and a sear, and wherein the trigger assembly is at a side portion of the bolt carrier; and
a gas system connected between the bolt carrier system and the barrel.

2. A rifle as in claim 1 wherein the trigger assembly is mounted at an angled side portion of the bolt carrier, and wherein the trigger assembly is at an angle with respect to lateral side portions of the rifle.

3. A rifle as in claim 1 further comprising a slide between the gas system and the bolt carrier system, wherein the body receiver comprises a one piece member, and wherein the body receiver houses the bolt carrier system, the trigger assembly, the gas system, the slide, and at least a portion of the barrel.

4. A rifle as in claim 1 further comprising a cocking/charging handle at the body receiver, wherein the cocking/charging handle is configured to allow for direct operation and non-reciprocation during firing of the weapon.

5. A rifle as in claim 1 wherein the rifle comprises a bullpup self loading rifle adapted to fire .50 BMG rounds.

6. A rifle as in claim 1 further comprising a dust cover connected to the body receiver, wherein the dust cover is configured to be actuated by a movement of the bolt carrier.

7. A rifle as in claim 1 wherein the bolt of the bolt carrier system is adapted for an extended locking rotation, wherein the locking rotation is about forty five degrees.

8. A rifle as in claim 1 wherein the bolt carrier system and the trigger assembly are configured to allow for side hammer cocking and firing.

9. A rifle as in claim 1 wherein the trigger assembly comprises a removable trigger assembly, and wherein the rifle further comprises a combination tool tray, and wherein the rifle includes an adjustable recoil absorption option.

10. A rifle as in claim 1 wherein the gas system comprises regulator valve and a short stroke piston, wherein the gas system is configured to operate without imparting gas residue on the bolt carrier system and the trigger assembly.

11. A gas operated weapon comprising:
a body receiver having a first side, a second side, and an ejection port, wherein the ejection port is at the first side;
a barrel extending from an end of the body receiver;
a bolt carrier system movably connected in the body receiver, wherein the bolt carrier system comprises a bolt and a bolt carrier;
a trigger assembly connected to the bolt carrier system, wherein the trigger assembly is proximate the second side of the body receiver; and
a dust cover connected to the first side of the body receiver, wherein at least a portion of the dust cover is over the ejection port, wherein the dust cover is configured to open in response to a movement of the bolt carrier system in a first direction, and wherein the dust cover is configured to close in response to a movement of the bolt carrier system in a second different direction.

12. A gas operated weapon as in claim 11 wherein the first direction comprises a direction towards a front end of the gas operated weapon, and wherein the second different direction comprises a direction towards a rear end of the gas operated weapon.

13. A gas operated weapon as in claim 11 wherein the trigger assembly is mounted at a side ramp of the bolt carrier, wherein the trigger assembly is at an angle relative to a horizontal plane of the weapon, and wherein the angle is about thirty degrees.

14. A gas operated weapon as in claim 11 wherein the dust cover is configured to be biased in a closed position, and wherein the dust cover is configured to only open during operation of the weapon to release fired and/or un-fired cartridge cases.

15. A gas operated weapon as in claim 11 wherein the trigger assembly comprises a two piece trigger and trigger rod firing system configured for allowing stripping of a lower receiver from an upper receiver with the trigger rod remaining in the upper receiver.

16. A gas operated weapon as in claim 11 further comprising a muzzle brake comprising a baffles portion.

17. A gas operated weapon as in claim 11 further comprising a recoil spring configured to allow for varying the spring wire diameter for altering the cycle rate of the weapon.

18. A gas operated weapon as in claim 11 further comprising a slide between the bolt carrier system and the body receiver, wherein the bolt carrier system and the slide are configured to be removable from the gas system, and wherein the bolt carrier system is configured to be removable from the weapon without separating an upper receiver of the weapon from a lower receiver of the weapon.

19. A method comprising:
providing a body receiver;
providing a barrel at the body receiver, wherein the barrel extends from an end of the body receiver;
providing a bolt carrier system in the body receiver, wherein the bolt carrier system comprises a bolt and a bolt carrier;
connecting a trigger assembly to the bolt carrier system;
connecting a gas system between the bolt carrier system and the barrel; and
connecting a dust cover to the body receiver, wherein the dust cover is proximate one side of the bolt carrier system, and wherein the trigger assembly is proximate another different side of the bolt carrier system.

20. A method as in claim 19 further comprising providing a tool tray proximate an opposite end of the body receiver.
